(19) United States
(12) Patent Application Publication
(10) Pub. No.: US 2007/0280221 A1
(43) Pub. Date: Dec. 6, 2007

(54) Telephone system, telephone exchange apparatus, and route switching method

(75) Inventor: Kenichi Kitazawa, Hino-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/806,410

(22) Filed: May 31, 2007

(30) Foreign Application Priority Data
May 31, 2006 (JP) 2006-152756

(51) Int. Cl. H04L 12/66

(52) U.S. Cl. 370/356

(57) ABSTRACT

According to one embodiment, a telephone system provided with a plurality of telephone exchange apparatuses, wherein each telephone exchange apparatus accommodates a plurality of telephone terminals, includes a route creating unit configured to derive a first communication route being established between a first telephone terminal accommodated in a first telephone exchange apparatus and a second telephone terminal accommodated in a second telephone exchange apparatus, in response to a communication request, a receiving unit configured to receive a switching request from either one of the first and second telephone terminals to switch the first communication route to another communication route, and a determination unit configured to determine a second communication route, based on predetermined conditions for selecting a route, when receiving the switching request, wherein, the first and second telephone exchange apparatuses switch the first communication route to the second communication route based on the determination result of the determination unit.

### CROSS-REFERENCE TO RELATED APPLICATIONS

This application is based upon and claims the benefit of priority from Japanese Patent Application No. 2006-152756, filed May 31, 2006, the entire contents of which are incorporated herein by reference.

### BACKGROUND

1. Field

One embodiment of the present invention is related to a telephone system in which communication is carried out by, for example, connecting a plurality of telephone exchange apparatuses via private network, and connecting an extension terminal or external line connected to one telephone exchange apparatus and an extension terminal or external line connected to another telephone exchange apparatus via a plurality of telephone exchange apparatuses and private networks.

2. Description of the Related Art

An exchange network system is designed to connect telephone exchange apparatuses, such as a PBX (Private Branch Exchange), a key telephone apparatus, or an IP Telephone system (an end point system is said, too) placed in, for instance, each branch or office of a company possessing a plurality of branches and offices, via private network. Needless to say, this type of system enables each telephone exchange apparatus intra-company calls and external line connection with, for instance, a public network. It also enables intra-company calls between different telephone exchange apparatuses and external line transmission/reception via different telephone exchange apparatuses.

In the above exchange network system, a communication route is switched upon the occurrence of transfer request. In the process switching routes, a short distance route is selected as the switching destination of the communication route by comparing a transit counter value, i.e., the number of relaying telephone exchange apparatuses, from among a plurality of communication routes potential as switching destinations (for example, Jpn. Pat. Appln. KOKAI Publication No. 2001-274901).

However, in the above method, a short distance route will always be chosen as the destination of the switched communication route. Therefore, although it may shorten the transmission time of voice signals in the communication route of the switched destination, the communication route cannot be switched in accordance with various conditions, such as connection means (line exchange connection and IP (Internet Protocol) connection) connection, voice quality or service types.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic view illustrating an exchange network system concerned in a first embodiment of the present invention.

FIG. 2 is a block diagram illustrating the functional configuration of a main apparatus shown in FIG. 1.

FIG. 3 illustrates an example of the memory content of a route table shown in FIG. 2.

FIG. 4 illustrates an example of the memory content of a user information table shown in FIG. 2.

FIG. 5 illustrates an example of the format of a transfer request message used in the first embodiment.

FIG. 6 is a sequence diagram illustrating a communication transfer operation in the first embodiment.

FIG. 7 is a flowchart illustrating the control processing procedure of the main apparatus in the first embodiment.

FIG. 8 illustrates an operation example in the case where a communication route is chosen by connection means in the first embodiment.

FIG. 9 illustrates an operation example in the case where the communication route is chosen by voice quality in the first embodiment.

FIG. 10 is a sequence diagram illustrating the transfer operation by Call Forward in a second embodiment of the present invention.

FIG. 11 is a sequence diagram illustrating transmission/reception operation of information in the case where a path is switched between two users in a third embodiment of the present invention.

### DETAILED DESCRIPTION

Various embodiments according to the invention will be described hereinafter with reference to the accompanying drawings, In general, according to one embodiment of the invention, a telephone system provided with a plurality of telephone exchange apparatuses, wherein each telephone exchange apparatus accommodates a telephone terminal of at least one of a plurality of extension telephone terminals and an external telephone terminal, the individual telephone exchange apparatus being connected to at least one of the telephone exchange apparatuses by a private network, comprising: a route creating unit configured to derive a first communication route being established between a first telephone terminal accommodated in a first telephone exchange apparatus of the plurality of telephone exchange apparatuses and a second telephone terminal accommodated in a second telephone exchange apparatus different from the first telephone exchange apparatus, in response to a communication request; a receiving unit configured to receive a switching request from either one of the first telephone terminal and the second telephone terminal to switch the first communication route to another communication route; and a determination unit configured to determine a second communication route different from the first communication route, based on predetermined conditions for selecting a route, when receiving the switching request; wherein, the first and second telephone exchange apparatuses switch the first communication route to the second communication route based on the determination result of the determination unit.

### First Embodiment

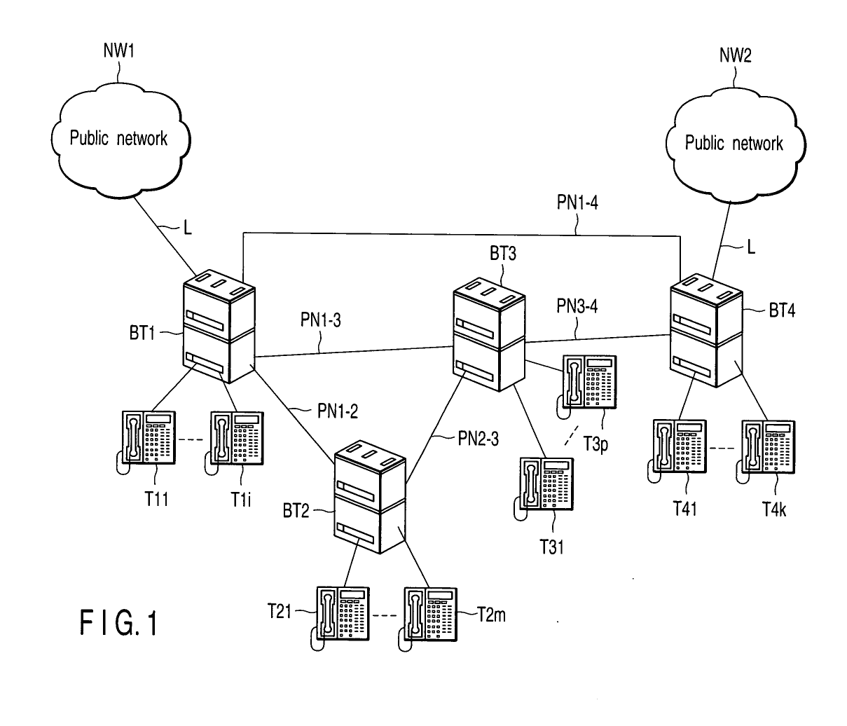

FIG. 1 is a schematic view illustrating the exchange network system concerned in a first embodiment of the present invention.

As illustrated in the drawing, the present system comprises key telephone main apparatuses (hereinafter referred to as main apparatus) BT1 to BT4, which are mutually connected by private networks PN (PN1-2, PN1-3, PN1-4, PN2-3 and PN3-4). These main apparatuses BT1 to BT4 accommodate extension terminals T11 to T1i, T21 to T2m, T31 to T3p and T41 to T4k respectively. Further, the main apparatuses BT1 and BT4 are respectively connected to public networks NW1 and NW2 via external lines L.

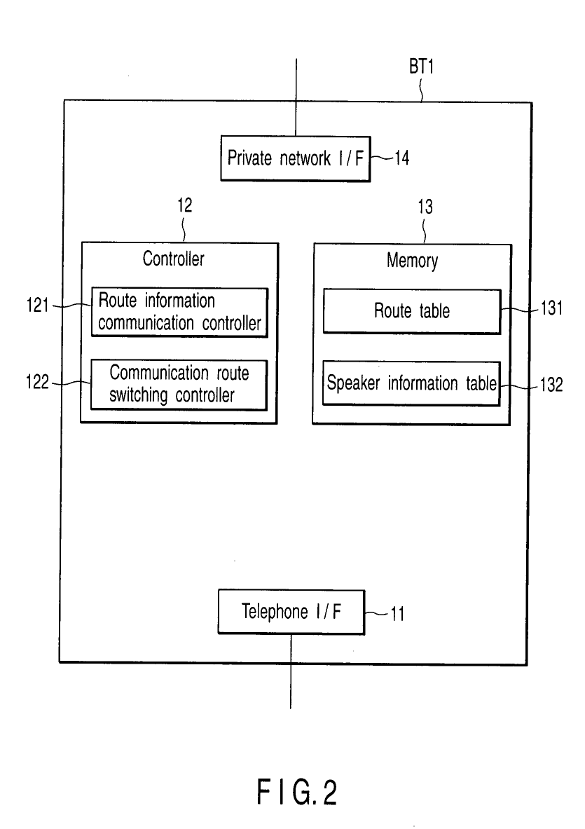

FIG. 2 is a block diagram illustrating a functional configuration of the above main apparatuses BT1 to BT4. Here, the main apparatus BT1 will be taken as an example.

The main apparatus BT1 comprises a telephone interface (I/F) unit 11, a controller 12, a memory 13 and a private network interface unit (I/F) 14. The telephone interface unit 11 performs interface processing between extension terminals T11 to T1i or the external line L.

The private network interface unit 14 transmits and receives data between the other main apparatuses BT2 to BT4 via the private network PN.

The memory 13 stores, for instance, routing information necessary for a connection control by the controller 12. Further, the memory 13 comprises a route table 131 and a user information table 132.

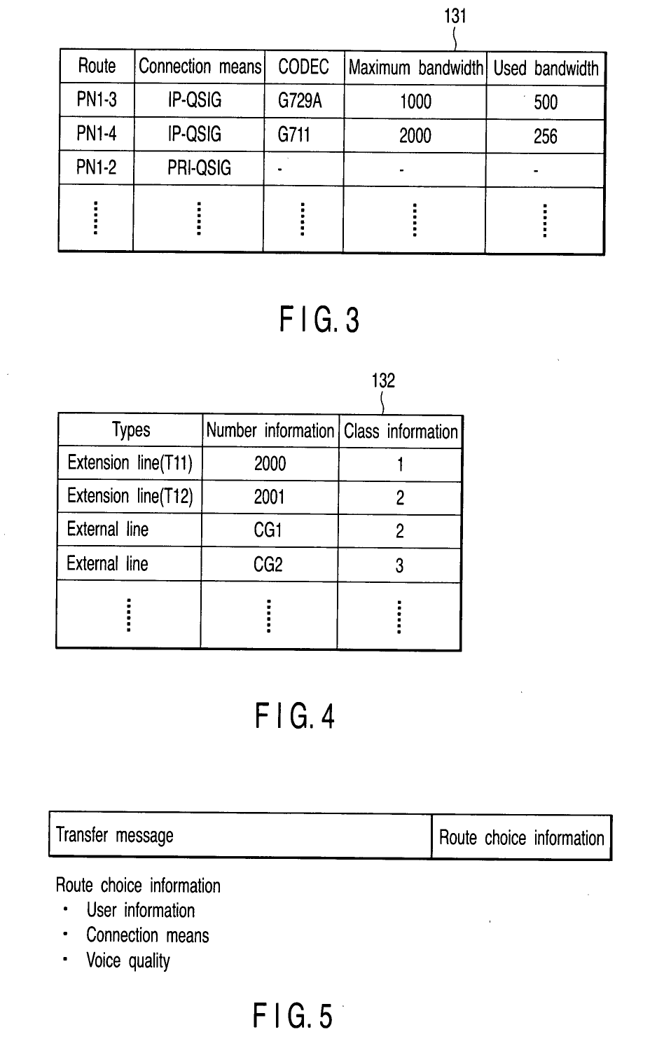

As illustrated in FIG. 3, the route table 131 stores data indicating corresponding relations of a route including private network PN, connection means, voice quality (CODEC), maximum bandwidth, and used bandwidth. Here, it is supposed that the main apparatuses BT1 and BT2 are connected by a line exchange connection of PRI-QSIG, and the main apparatuses BT1 and BT4 are connected by an IP connection of IP-QSIG.

As illustrated in FIG. 4, the user information table 132 stores data indicating corresponding relations of information (types) of each of the extension terminals T11 to T1i, T21 to T2m, T31 to T3p, T41 to T4k and external line L, as well as number information and regulation class of services that can be provided by each of the extension lines and external line thereof. Further, in the case of external line, the class can be divided in terms of lines or units of groups, or the sender information received from a station.

In addition to possessing the exchange control function for the extension terminals T11 to T1i, T21 to T2m, T31 to T3p, T41 to T4k and external line L, the controller 12 comprises a route information communication controller 121 and a communication route switch controller 122 as new functions concerned in the present invention.

As illustrated in FIG. 5, when a communication transfer request occurs, the route information communication controller 121 inserts data stored on the route table 131 and the user information table 132 as a route choice information into a message to be sent to a communication counterpart or a transfer destination. The route information communication controller 121 then transmits such message and also receives incoming messages.

The communication route switch controller 122 carries out switching control of a communication route based on the route choice information inserted in the received message.

The operation of the exchange network system as configured above will be explained.

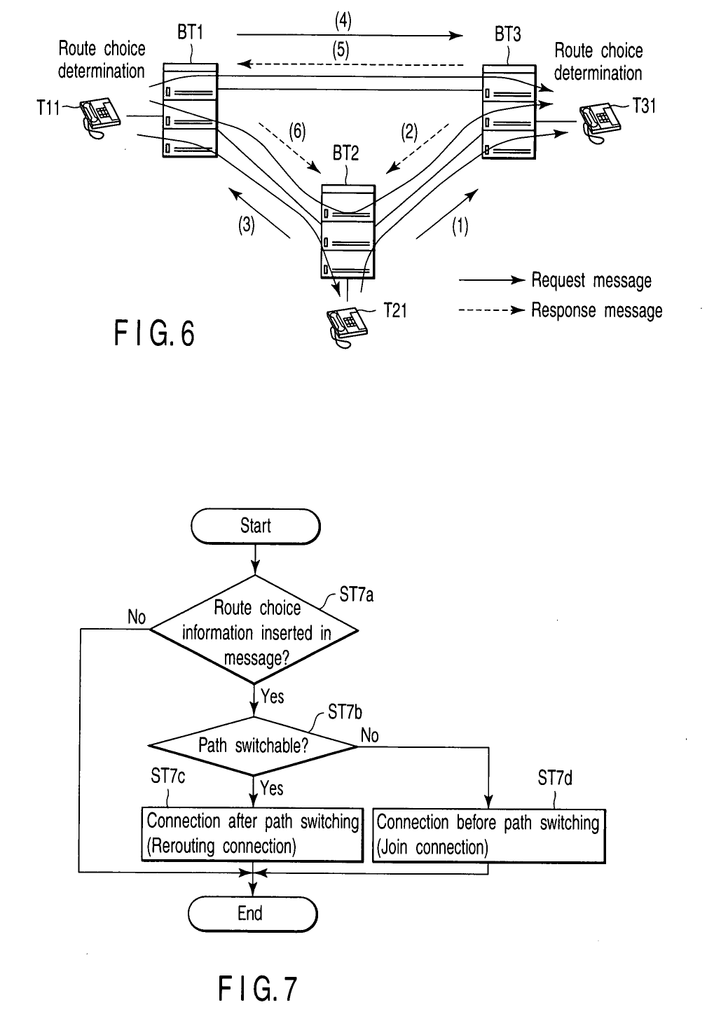

FIG. 6 is a sequence diagram illustrating the transmitting and receiving operation of information in the case where the user of the extension terminal T21 transfers a call from the user of extension terminal T11 to the user of extension terminal T31.

Prior to FIG. 6, the user of extension terminal T11 dials the extension terminal T21, adds the user information and route choice information for communication to the message and notifies this from the main apparatus BT1 to the main apparatus BT2.

In this state, suppose the user of the extension terminal T21 carries out an operation to request transfer of the communication between the extension terminal T11 and the extension terminal T21 to the extension terminal T11 and the extension terminal T31. In such case, the extension terminal T21 sends such request signal to the main apparatus BT2.

Having received this transfer request, the main apparatus BT2 suspends the communication route between the extension terminal T11 and sends a communication establishment request to the transfer destination, extension terminal T31. Then, the route choice information for communication is added to the message and notified from the main apparatus BT2 to the main apparatus BT3 and vice versa.

As disconnection operation is done by the user of the extension terminal T21, the main apparatus BT2 carries out the transfer operation.

During this process, the main apparatus BT2 transmits a path switching request (1) to the main apparatus BT3, receives response (2) from the main apparatus BT3, and transmits a transfer implement request for path switching (3) to the main apparatus BT1. With this, the main apparatus BT2 notifies the main apparatus BT3 or the main apparatus BT1 of the route choice information between the main apparatus BT1-main apparatus BT2 and the main apparatus BT2-main apparatus BT3.

Having received the transfer implement request for switching paths from the main apparatus BT2, the main apparatus BT1 performs control processing as illustrated in FIG. 7.

In this process, firstly, the main apparatus BT1 determines whether or not the route choice information is inserted in the transfer implement request (block ST7a). Then, in the case where the route choice information is inserted, the main apparatus BT1 determines whether or not the path is switchable, based on the route choice information (block ST7b).

Here, if the path is switchable, the main apparatus BT1 requests rerouting (4) to the main apparatus BT3 and establishes direct connection with the main apparatus BT3 (block ST7c).

The main apparatus BT1 transmits and receives the route choice information by requesting rerouting (4) and receiving the result of transfer thereof (5). As a result, the main apparatus BT1 determines whether the connection should be a join connection or rerouting connection and notifies the main apparatus BT2 or BT3.

If it is the rerouting connection, the main apparatus BT1-main apparatus BT2 is disconnected. If it is the join connection, the main apparatus BT1-main apparatus BT2 is disconnected, and the main apparatus BT1 notifies the main apparatus BT2 of the join connection (block ST7d).

If it is the join connection, the main apparatus BT2 maintains the communication connection of the main apparatus BT1-main apparatus BT2-main apparatus BT3, and notifies the main apparatus BT3 of necessary information.

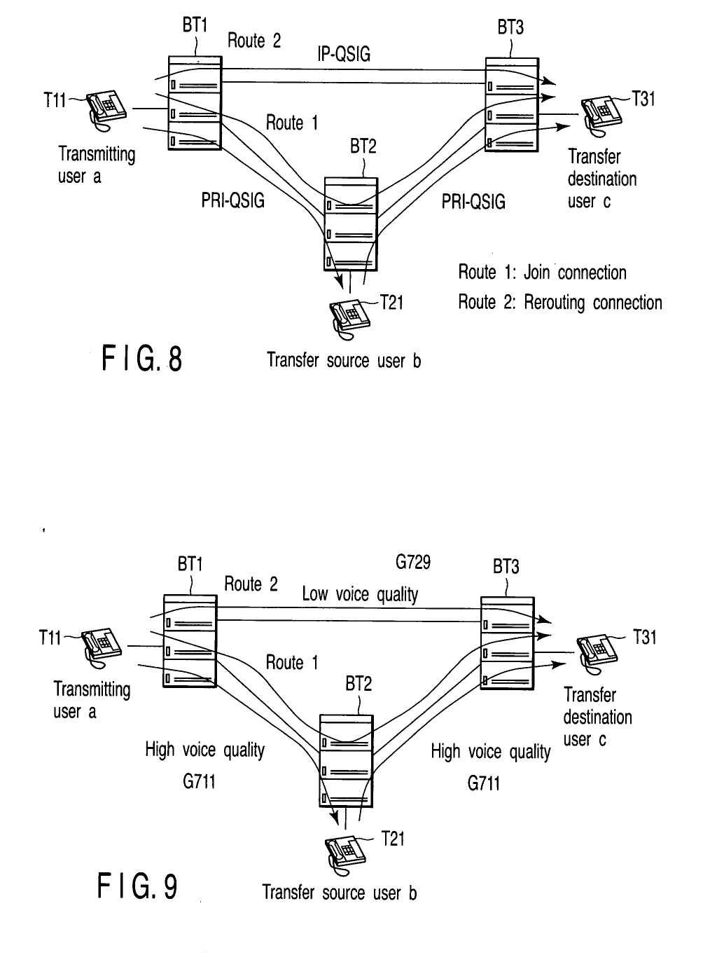

Further, in the case where, for example, the class information of the extension terminal T31 is “3”, which indicates an important user, the main apparatus BT1 and the main apparatus BT3 are connected via a private network PN1-2, the main apparatus BT2 and a private network PN2-3, as illustrated in FIG. 8. In other words, they are connected via “route 1”, which has high voice quality and high security. In addition, for example, in the case where the class information of the extension terminal T31 is “1”, i.e., not an important user, they are connected via a private network PN1-3, i.e., “route 22”, which has low voice quality.

In the above route choosing method, a route is determined depending on each call. In the case where the usage of channel is low, depending on whether connection can be made by a high voice quality in consideration of a sufficient bandwidth and the user's capability, a private network PN1-3, i.e., “route 2” may be chosen as illustrated in FIG. 9.

Further, in the case where a bandwidth available for data transfer by IP connection is insufficiency due to the condition of use, “route 1”, which is via the original private network PN1-2, main apparatus BT2 and private network PN2-3 is chosen.

As mentioned above, according to the first embodiment, when a communication transfer request from the extension terminal T21 to the extension terminal T31 occurs under a condition where the extension terminals T11 and T21 are communicating, the information indicating an arbitrarily combination of connection means, voice quality, channel availability of the communication route between main apparatuses BT1 and BT3, and user's information of extension terminals T11, T12 and T13 are notified among the main apparatuses BT1, BT2 and BT3 as the route choice information. The main apparatuses BT1 and BT3 choose an optimal communication route based on the notified route choice information.

Accordingly, an optimal communication route can be provided in accordance with the user's information between users, connection means of communication connection, voice quality, and the condition of channel usage, without having to set up a new exclusive signal.

In addition, it is also possible to prevent each phone call from voice quality deterioration caused by choosing the shortest route upon every path switching, or prevent efficiency reduction, which depends on the condition of channel use.

Further, according to the above first embodiment, the user of the extension terminal T21, which is the transfer source, can at least confirm whether or not the communication route has been switched due to its own request.

### Second Embodiment

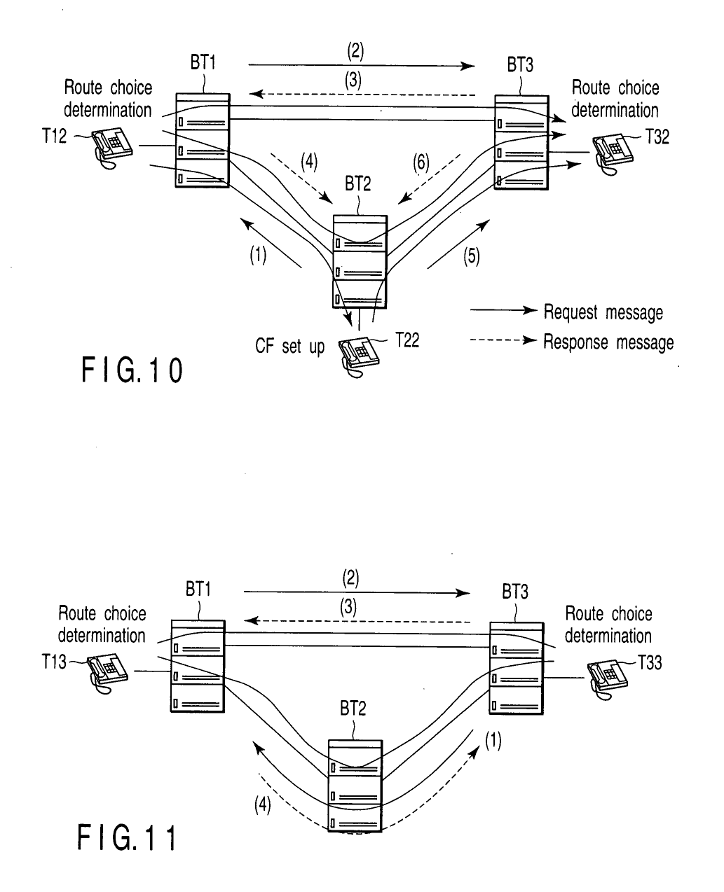

As a second embodiment of the present invention, FIG. 10 shows a sequence diagram illustrating transmission/reception operation of information in the case where an incoming call from the user of the extension terminal T12 to the user of the extension terminal T22 is transferred to the user c of the extension terminal T32 by Call Forward.

In this process, the user of the extension terminal T12 calls the user of the extension terminal T22. When doing so, the main apparatus BT1 added route choice information to the message and notified to the main apparatus BT2.

The extension terminal T22 is set up in advance to Call Forward to the extension terminal T32. A rerouting connection is initiated to transfer calls from the user of the extension terminal T12 to the user of the extension terminal T32. A rerouting connection request is notified from the main apparatus BT2 to the main apparatus BT3. At the same time, the main apparatus BT2 notifies the main apparatus BT3 of the route choice information in the case where connection is made from the main apparatus BT2 to the main apparatus BT3.

Prior to rerouting transmission, the main apparatus BT1 determines from the routing choice information whether to choose a join connection or a rerouting connection. In the case of choosing the rerouting connection, the main apparatus BT1 performs rerouting transmission. Meanwhile, in the case of choosing a join connection, the main apparatus BT1 notifies the main apparatus BT2 that the rerouting connection cannot be made.

In the case where rerouting connection cannot be made, the main apparatus BT2 transmits a request of join connection to the main apparatus BT3.

In the case of the rerouting connection, the main apparatus BT3 notifies the result to the main apparatus BT1. Meanwhile, in the case of the join connection, the result is notified from the main apparatus BT3 to the main apparatus BT2.

Accordingly, the same effects and advantages as in the above first embodiment can be obtained even in the above second embodiment.

### Third Embodiment

As a third embodiment of the present invention, FIG. 11 shows a sequence diagram illustrating the transmission/reception operation of information in the case where there is a path switching in a call communicated between the user of the extension terminal T13 and the user of the extension terminal T33 via the main apparatus BT2.

For example, suppose the user of the extension terminal T33 requests a path switching with respect to the extension terminal T13. In such case, the main apparatus BT3 transmits a message of path change request to the main apparatus BT1 via the main apparatus BT2. When doing so, the message with route choice information added thereto is notified among the main apparatus BT3-main apparatus BT2-main apparatus-BT1. In other words, the main apparatus BT2, which becomes the relay node, updates the received route choice information of the main apparatus BT3 and notifies it to the main apparatus BT1. Finally, the main apparatus BT1 is notified of the route information among the main apparatus BT1-main apparatus BT2-main apparatus BT3.

Before transmitting the request of path switching from the main apparatus BT1 to the main apparatus BT3, the main apparatus BT1 chooses a route of the connection before path switching and a route of the connection after path switching based on the route choice information. If the connection before path switching is optimum, path switching is not carried out and denial of path switching (4) is notified from the main apparatus BT1 to the main apparatus BT3 via the main apparatus BT2. If the connection after path switching is optimum, path switching is carried out from the main apparatus BT1 to the main apparatus BT3.

In the case of receiving denial of the path switching, the main apparatus BT3 does not do path switching. In the case of receiving an incoming call due to path switching, the main apparatus BT3 notifies the result of the path switching to the main apparatus BT1.

Further, in the case of adding the route choice information to the message, the route choice information of its own node is added. In the case of going through a relay node, the route choice information of the relay node is added and notified to the last node. For example, when adding the route choice information, an identifier is added to each type of route choice information, and when it is relayed, the number of the relay nodes is counted.

Accordingly, in the above third embodiment, various conditions are taken into account upon the occurrence of communication route switching request. Such various conditions include the connection means, voice quality, types of services concerned in the communication, availability of communication route channels and user information, in addition to the number of relayed main apparatuses.

Therefore, in comparison to the conventional scheme in which a short communication route was mostly chosen, the present embodiment allows the communication route to be switched to an optimal communication route in accordance with each various condition.

### Other Embodiments

The present invention is not restricted to each of the above embodiments. For instance, each of the above embodiments explains an example of choosing an optimal communication route by the combination of connection means, voice quality, types of services concerned in communication, availability communication route channels and user information. However, this is not restricted. Therefore, it is also fine to use the type of service concerned in communication as the condition for choosing the communication route.

In addition, each of the above embodiments explains an example of switching communication routes among a plurality of different extension terminals having different main apparatuses. However, it can also be applied in the case of switching communication routes among external lines having different main apparatuses.

Other various modifications can be made within the scope of the present invention, with regard to the type of telephone exchange apparatuses (it is not restricted to a main apparatus, and a PBX may be used) and the type of extension terminals, the content stored on each type of table, the type of route choice information, communication control procedure of the route choice information and the controlling procedure of switching communication routes.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system provided with a plurality of telephone exchange apparatuses, wherein each telephone exchange apparatus accommodates a telephone terminal of at least one of a plurality of extension telephone terminals and an external telephone terminal, the individual telephone exchange apparatus being connected to at least one of the telephone exchange apparatuses by a private network, comprising:
a route creating unit configured to derive a first communication route being established between a first telephone terminal accommodated in a first telephone exchange apparatus of the plurality of telephone exchange apparatuses and a second telephone terminal accommodated in a second telephone exchange apparatus different from the first telephone exchange apparatus, in response to a communication request;
a receiving unit configured to receive a switching request from either one of the first telephone terminal and the second telephone terminal to switch the first communication route to another communication route; and
a determination unit configured to determine a second communication route different from the first communication route, based on predetermined conditions for selecting a route, when receiving the switching request;
wherein,
the first and second telephone exchange apparatuses switch the first communication route to the second communication route based on the determination result of the determination unit.

2. The telephone system according to claim 1, wherein,
the determination unit uses any one of or a combination of a connection method, communication quality, type of service concerned in communication, channel usage condition of communication route, and user information of the first and second telephone terminals as the above condition.

3. The telephone system according to claim 1, wherein,
the first and second telephone exchange apparatuses further notify the result of switching the first communication route to the second communication route to the telephone terminal of the request source.

4. The telephone system according to claim 1, wherein,
the receiving unit further receives a transfer request transmitted from either one of the first and second telephone terminals, to connect the first telephone terminal to a third telephone terminal accommodated in a third exchange apparatus different from the first and second telephone exchange apparatuses,
the determination unit collects route information indicating conditions for selecting each route of the first and third telephone exchange apparatuses when receiving the transfer request, and determines a third communication route for connecting the first telephone terminal and the third telephone terminal based on these route information, and
the first, second and third telephone exchange apparatuses switch the first communication route to the third communication route based on the determination result of the determination unit.

5. The telephone system according to claim 1, wherein,
the receiving unit further receives a transfer request by Call Forward from the second telephone terminal, to connect the first telephone terminal to a third telephone terminal accommodated in a third exchange apparatus different from the first and second telephone exchange apparatuses, before the first communication route is connected between the first and second telephone terminals,
the determination unit collects route information indicating conditions for selecting each route of the first and third telephone exchange apparatuses when receiving the transfer request, and determines a third communication route for connecting the first telephone terminal and the third telephone terminal based on these route information, and
the first, second and third telephone exchange apparatuses connect between the first telephone terminal and the third telephone terminal by the third communication route based on the determination result of the determination unit.

6. The telephone exchange apparatus used in a telephone system provided with a plurality of telephone exchange apparatuses, wherein each telephone exchange apparatus accommodates a telephone terminal of at least one of a plurality of extension telephone terminals and an external telephone terminal, the individual telephone exchange apparatus being connected to at least one of the telephone exchange apparatus by a private network, comprising:
a route creating unit configured to derive a first communication route being established between a first telephone terminal accommodated in the said telephone exchange apparatus and a second telephone terminal accommodated in another telephone exchange apparatus, in response to a communication request;
a receiving unit configured to receive a switching request from either one of the first and second telephone terminals, to switch the first communication route to another communication route;
a determination unit configured to determine a second communication route different from the first communication route, based on conditions for selecting a predetermined route, when receiving the switching request; and
a switching unit configured to switch the first communication route to the second communication route based on the determination result of the determination unit.

7. The telephone exchange apparatus according to claim 6, wherein,
the determination unit uses any one of or a combination of a connection method, communication quality, type of service concerned in communication, channel usage condition of communication route, and user information of the first and second telephone terminals.

8. The telephone exchange apparatus according to claim 6, wherein,
the switching unit further notifies the result of switching the first communication route to the second communication route to the telephone terminal of the request source.

9. The telephone exchange apparatus according to claim 6, wherein,
the receiving unit further receives a transfer request transmitted from either one of the first and second telephone terminals, to connect the first telephone terminal to a third telephone terminal accommodated in a third exchange apparatus different from the first and second telephone exchange apparatuses,
the determination unit collects route information indicating conditions for selecting a route between the third telephone exchange apparatus when receiving the transfer request, and determines a third communication route for connecting the first telephone terminal and a third telephone terminal based on these route information, and
the switching unit switches the first communication route to the third communication route based on the determination result of the determination unit.

10. The telephone exchange apparatus according to claim 6, wherein,
the receiving unit further receives a transfer request by Call Forward from the second telephone terminal, to connect the first telephone terminal to a third telephone terminal accommodated in a third exchange apparatus different from the first and second telephone exchange apparatuses, before the first communication route is connected between the first and second telephone terminals,
the determination unit collects route information indicating conditions for selecting a route between the third telephone exchange apparatus when receiving the transfer request, and determines a third communication route for connecting the first telephone terminal and the third telephone terminal based on these route information, and
the route creating unit connects between the first telephone terminal and the third telephone terminal by the third communication route based on the determination result of the determination unit.

11. A route switching method used in a telephone system provided with a plurality of telephone exchange apparatuses, wherein each telephone exchange apparatus accommodates a telephone terminal of at least one of a plurality of extension telephone terminals and an external telephone terminal, the individual telephone exchange apparatus being connected to at least one of the telephone exchange apparatuses by a private network, comprising:
deriving a first communication route being established between a first telephone terminal accommodated in a first telephone exchange apparatus of the plurality of telephone exchange apparatuses and a second telephone terminal accommodated in a second telephone exchange apparatus different from the first telephone exchange apparatus, in response to a communication request;
receiving a switching request to switch a first communication route to another communication route, the switching request is transmitted by either one of the first telephone terminal and the second telephone terminal;
determining a second communication route, which is different from the first communication route, based on conditions for selecting a predetermined route, when receiving the switching request; and
switching the first communication route to the second communication route based on the determination result.
